(19) United States
(12) Patent Application Publication
(10) Pub. No.: US 2002/0146296 A1
(43) Pub. Date: Oct. 10, 2002

(54) Method and device for avoiding chatter during machine tool operation

(75) Inventors: Tony L. Schmitz, Jefferson, MD (US); Matthew A. Davies, Charlotte, NC (US)

Correspondence Address: Charles E. Rohrer, P.C., P.O. Box 20067, Boulder, CO, 80308, US

(73) Assignee: National Institute of Standards and Technology, Washington, DC

(21) Appl. No.: 10/082,921

(22) Filed: Feb. 26, 2002

Related U.S. Application Data
(60) Provisional application No. 60/271,396, filed on Feb. 26, 2001.

(51) Int. Cl. B23C 9/00

(52) U.S. Cl. 409/131; 409/141; 82/1.11; 82/163

(57) ABSTRACT

In milling operations, periodically sensed vibration signals synchronous with tool revolution enables a determination of whether the tool returns to approximately the same position each revolution. If so, stability is indicated by tightly grouped values of the periodically sensed vibration signal. If the tool does not return to the same position, spread in the value of the periodically sampled vibration signals is produced thereby indicating chatter conditions. Variance values may be calculated and displayed; histograms may be produced and displayed; corrective action, if needed, may be taken in response to the variance values and/or histogram. Nominal (or commanded) spindle speed, while not necessarily exactly synchronous with actual tool rotation, is entirely adequate to trigger samples and achieve clear indication of the presence or absence of chatter.

This application claims the benefit of U.S. Provisional Patent Application No. 60/271,396 filed Feb. 26, 2001 and is an invention of the National Institute of Standards and Technology, Department of Commerce, United States Government.

The invention relates to milling and other material removal operations and more particularly to method and device for alerting machine operators to chatter conditions.

### BACKGROUND OF THE INVENTION

Milling and other material removal processes are performed by engaging the cutting teeth of a tool with a workpiece. A complex dynamic process results which can produce undesirable self-excited vibrations usually called chatter between the tool and the workpiece. Parameters which effect vibratory motions include the spindle speed, tool geometry and sharpness, workpiece material, tool and workpiece stiffness and damping, and feed rate of the tool through the material. The cutting operation includes periodic impacts of cutting teeth with the workpiece, thereby setting up vibrations between the two. These vibrations cause a wavy undulating surface to be left by the cutting tool. Removal of the undulating surface produced by the preceding tooth with the current tooth produces a regeneration of waviness and is a primary source of instability in milling and other material removal operations. Regeneration of waviness leads to a variable chip thickness, and therefore, to a variable cutting force which can lead to increased vibrations of the tool. The resulting closed loop feedback in force variation provides the mechanism for the production of chatter. The ultimate result is poor quality of the machined surface, high force levels, and potential damage to the workpiece and/or machine.

An important analytic tool that has been developed to aid in the selection of stable cutting parameters is the stability lobe diagram. These diagrams enable the user to select the appropriate combination of chip width, i.e. instantaneous depth of cut, and spindle speed by separating stable from unstable regions with the analytic “lobes.” Construction of stability lobe diagrams requires pre-process knowledge of the cutting operation, including the tool point frequency response function and specific cutting energy coefficients that depend on the workpiece material, tool geometry, and cutting parameters. Cutting energy coefficients are typically obtained through a series of costly machining tests for each material/tool combination and maintained in a database. The tool point frequency response function (FRF) is usually obtained by impact testing where an instrumented hammer is used to excite the tool and the resulting vibration recorded using an accelerometer or capacitance probe. The FRF differs for each tool/holder/spindle combination. Production of the FRF is time consuming and requires a trained technician to complete the measurement. As a result, the calculation of optimum milling conditions using stability lobe diagrams is often neglected due to inadequate engineering support, especially in moderately sized job shops. The current invention is a device and method with the ability of identifying approaching chatter conditions through an in-process technique that does not require pre-process activity by trained technicians or engineers.

### SUMMARY OF THE INVENTION

Briefly stated, the invention is a device and method for identifying chatter conditions utilizing a first signal, such as an audio, displacement, acceleration, or force signal, which is capable of identifying chatter in the material removal operation. A second signal is provided at periodic intervals of tool revolution enabling sampling of the first signal in synchronism with tool revolution. By synchronously sampling the vibrations produced in the cutting operation, the stability of the operation is sensed since stable operation produces vibratory motion synchronous with spindle rotation. Physically, the tool returns to approximately the same position in each revolution under steady state stable conditions. In contrast, tool motion during regenerative chatter is not synchronous with spindle rotation; instead, vibrations occur near the natural frequency corresponding to the most flexible system mode, due to the nature of self-excited vibrations. When unstable cuts are sensed, it is because the tool has not returned to the same position each revolution. Therefore, by accumulating data over a sample window, the stability of the operation can be sensed and analysis of the accumulated data can be used to provide a display of the stability of the operation for the machine operator. If chatter or approaching chatter conditions are sensed, the machine operator can take corrective measures. The ability to accumulate and analyze the data may also be incorporated into machine tool controllers by manufacturers of such tools.

Implementation of the invention can be at any convenient sampling interval synchronous with tool revolution and is exampled herein as occurring once per revolution. Also, it has been found that data accumulated in synchronism with nominal or commanded spindle speed rather than using an independently generated sampling signal produces the ability to identify chatter. Therefore, as used herein, sampling in synchronism with tool rotation includes sampling in synchronism with nominal spindle rotation.

### BRIEF DESCRIPTION OF THE DRAWING

FIG. 1 is a block circuit diagram showing major system components of the invention.

FIG. 2 shows elements used in the circuit diagram of FIG. 1 to sample vibration signals in synchronism with tool revolutions.

FIG. 3A shows the cutting tool of FIG. 2 in juxtaposition with a workpiece for a 50% radial immersion milling operation.

FIG. 3B is a schematic diagram of the milling operation of FIG. 3A.

FIGS. 4 and 5 show vibratory motion of the cutting tool for stable and unstable milling operations.

FIGS. 6 and 7 show charts of variance values and histograms for stable and unstable milling operations.

FIG. 8 shows a chart of variance values using nominal spindle speed as the sampling parameter.

FIG. 9 is a flowchart of operations performed on the vibration signals to produce variance values and histograms.

FIG. 10 shows a sample display of variance values and histogram to visually indicate the presence or absence of chatter conditions.

### DETAILED DESCRIPTION

The above mentioned and other features and objects of the invention and the manner of obtaining them will become more apparent, and the invention itself will best be understood by reference to the following description of embodiments of the invention taken in conjunction with the accompanying drawing.

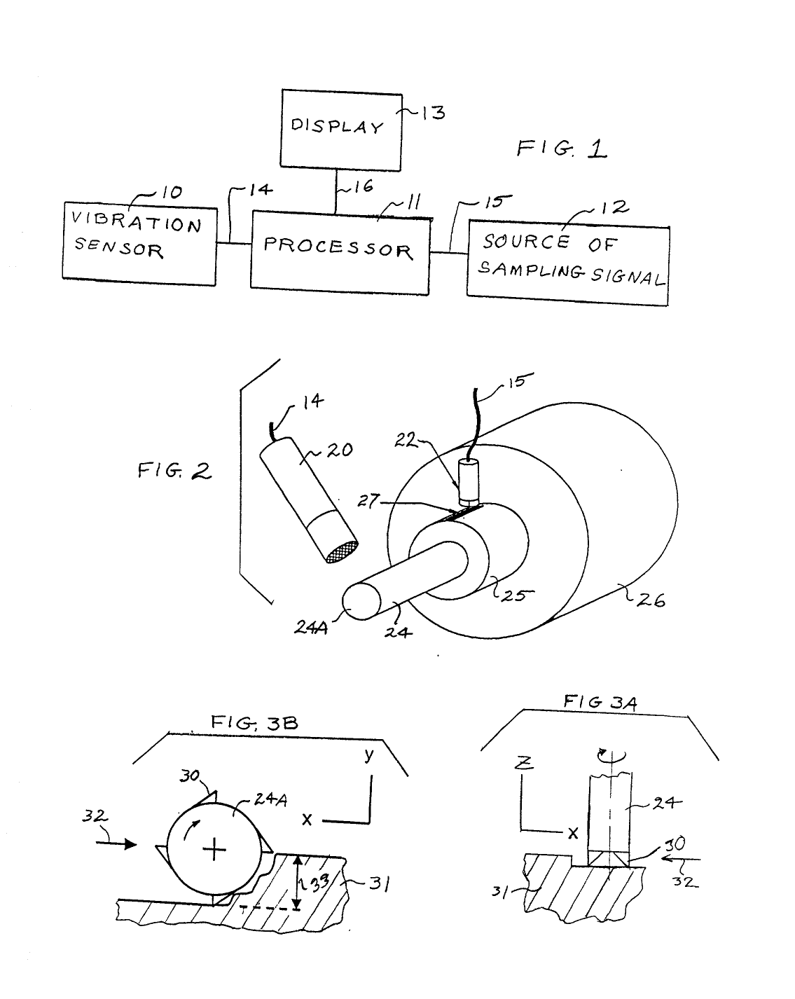

FIG. 1 shows a sensing device 10 placed near the tool workpiece interface in order to sense vibrations produced at the interface. The sensed signal is sent over line 14 to a processor 11 where it is sampled in synchronism with a signal received by processor 11 over line 15 from device 12. Device 12 produces a sampling signal in synchronism with spindle rotation, therefore in synchronism with tool revolutions. A display 13 may be provided to visually alert the machine operator to chatter conditions or approaching chatter conditions. Amplifiers and other such accessory components are not shown.

FIG. 2 shows one setup for implementing the invention wherein a microphone 20 is the sensing device for capturing an audio signal indicative of vibrations between the tool and the workpiece. Other vibration sensors could be used, for example, sensors to sense variations in displacement, force, acceleration, etc. FIG. 2 shows a tool 24 held by tool holder 25 and driven by a spindle 26. An emitter/detector 22 is positioned adjacent to the tool holder 25 in order to sense a reflective mark 27 passing under detector 22 once per revolution. The tool 24 may be, for example, an end mill although flutes are not shown on end surface 24A in FIG. 2.

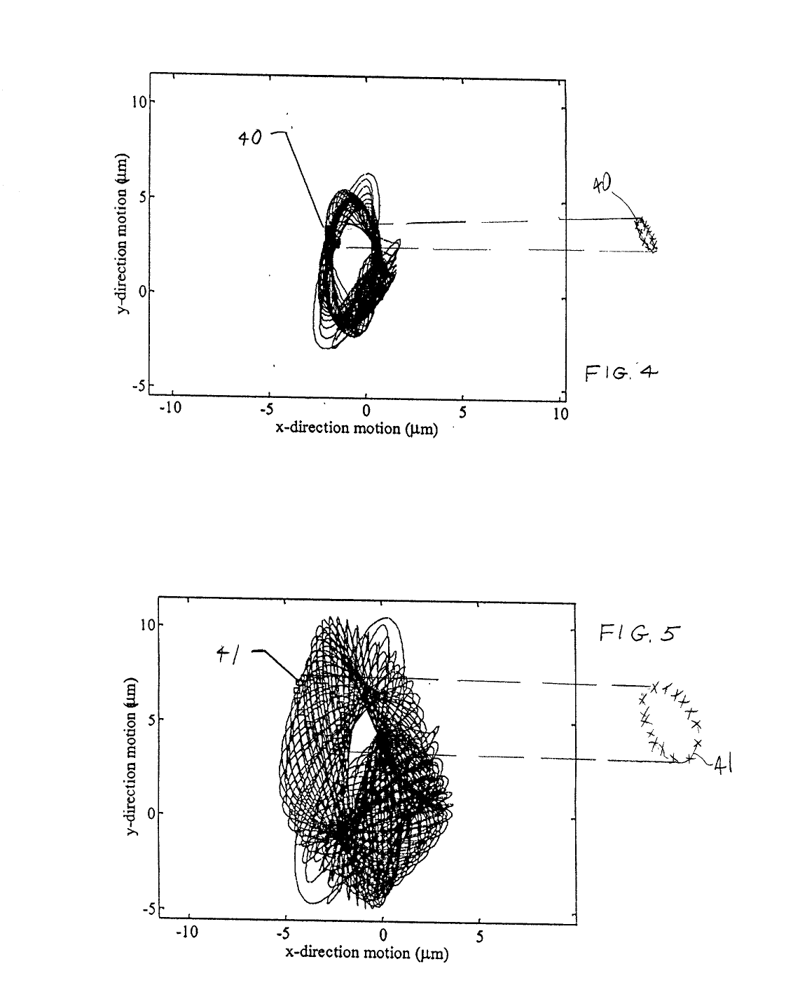

FIG. 3A shows an end mill 24 with two flutes (teeth) 30 in juxtaposition with a workpiece 31. As tool 24 is fed in direction 32, teeth 30 contact workpiece 31 and begin to remove material. FIG. 3B is a schematic diagram of the milling operation shown in FIG. 3A with four teeth 30 schematically represented on end surface 24A. FIGS. 3A and 3B show a 50% radial immersion operation, that is, the radial depth 33 of the cut is 50% of the diameter of the tool 24.

The x and y axes are the axes of end surface 24A and are shown in FIG. 3B to illustrate the axes of vibratory motion set up in the interface between tool and workpiece. A sensing device such as microphone 20 is placed near the tool/workpiece interface to sense that vibratory motion. Signals from microphone 20 are sampled in synchronism with tool rotation so that an analysis in accord with the invention can be made of the vibratory motion produced at the interface. The invention is based on the observation that when vibratory motion is stable the tool 24 returns to approximately the same position each revolution. Although the tool is vibrating in both the x and y directions in FIG. 4, at the time of sampling (once per revolution) the x, y plot of sampled tool position 40 is tightly grouped thereby showing the return of the tool to approximately the same position each revolution.

FIG. 5 shows a plot of x, y tool motion when regenerative chatter is present and tool motions are not synchronous with tool rotation; instead, they occur near the natural frequency corresponding to the most flexible system mode due to the nature of self-excited vibrations. FIG. 5 shows that the synchronously sampled points 41 (once-per-revolution) of tool position produce an elliptical shape vs. the much tighter, more linear shape shown in FIG. 4. The elliptical shape of sampled tool positions 41 is indicative of quasi-periodic motion and shows that the tool does not return to the same position each revolution when chatter is present.

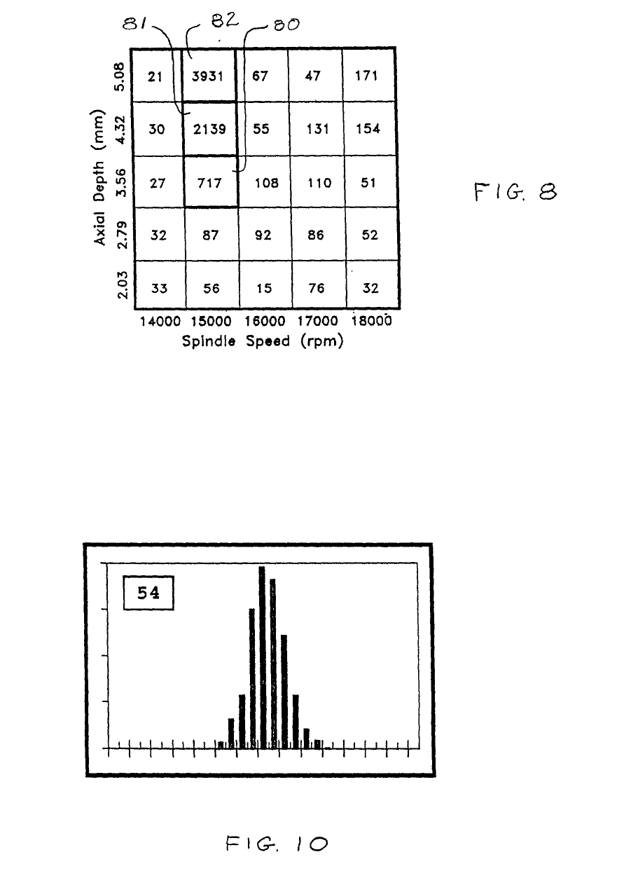

A histogram of the tightly spaced cluster of sampled signals produced for a stable cut such as shown in FIG. 4 can be produced and displayed so that a machine operator can visually observe the stability of the machining operation. Such a histogram is shown in FIG. 7, except for histograms 70, 71 and 72. When chatter is present, instability in the cut, due to regenerative chatter, demonstrates asynchronous motion and produces a set of signals similar to those shown in FIG. 5. A histogram of those sampled signals will give a more distributed set of samples with a much larger variance as shown at 70, 71 and 72. The histogram of those signals visually alerts the machine operator that instability is present and corrective action is needed. Similarly, as the displayed data tends to move from stable condition toward an unstable condition, a machine operator can visually observe increased variance and take corrective action prior to the time that chatter actually occurs to an extent that would damage the quality of the machining operation.

As the histograms in FIG. 7 show, there is a dramatically different distribution for the synchronously sampled data, thereby making it possible to distinguish between stable and unstable cutting conditions using only a once-per-revolution sampled process signal with adequate signal-to-noise ratio and some performance metric. Such a metric can be used alone or in conjunction with displayed histograms to alert a machine operator of approaching chatter conditions. The selected metric described below is a calculated number showing the statistical variance in the synchronously sampled milling audio signal 20. Variance was selected because it provides a measure of the spread in a sample distribution. The variance, σ², of sample distributions consisting of N values of signal, xᵢ, was calculated according to Equation 1 below, where xₘ is the mean or arithmetic average of the samples.

$${σ}^{2} = \frac{{\sum }_{i = 1}^{N} ( {x}_{i} - {x}_{m}^{2} )}{N - 1} , where {x}_{m} = \frac{{\sum }_{i = 1}^{N} {x}_{i}}{N} \qquad ( 1 )$$

Experimental verification of the invention was performed utilizing 50% radial immersion down-milling cutting tests with a 12.7 mm diameter, two flute, helical carbide end mill with a 44 mm overhang. The workpiece material was 6061-T6 aluminum. Twenty-five cutting tests were performed covering spindle speeds from 14000 rpm to 18000 rpm (1000 rpm steps) and axial depths from 2.03 mm to 5.08 mm (0.76 mm steps.) In all cases, a constant feed per tooth of 102 μm was maintained. The microphone and once-per-revolution sampling signals were obtained using the setup shown in FIG. 2. The microphone signal was analog low pass filtered at 7 kHz and both the microphone and once-per-revolution signals were collected using a sampling frequency of 50 kHz.

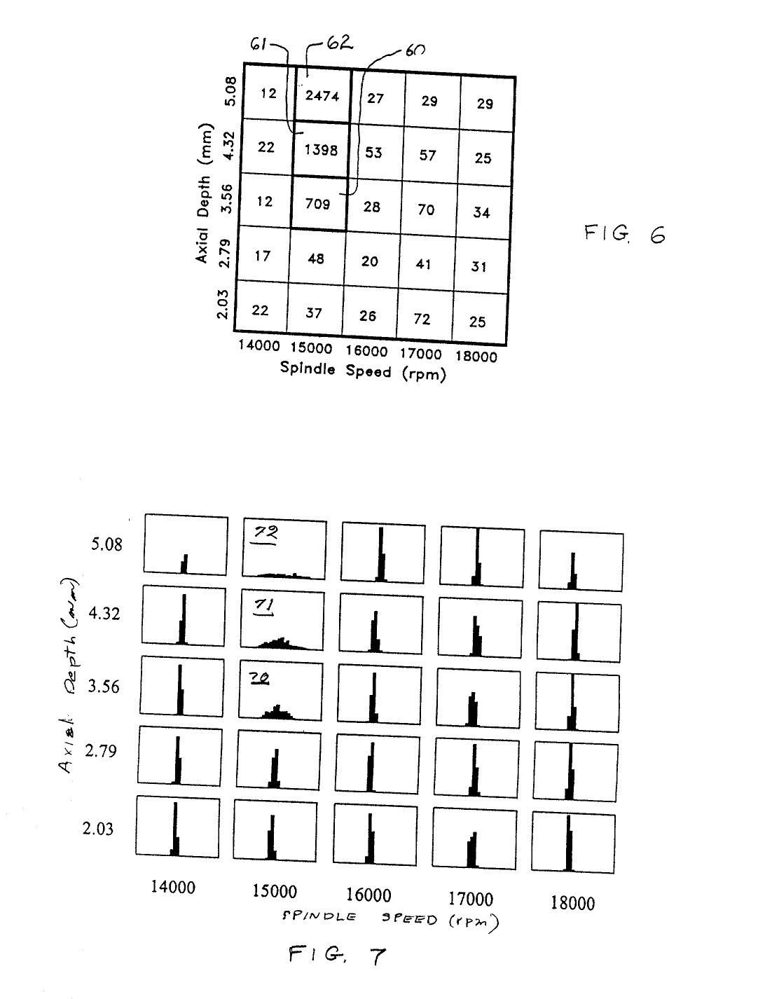

The first analysis method applied to the audio milling signal was to use the once-per-revolution signal obtained using the infrared emitter/detector 22 to sample the data directly, then calculate the variance in the result. The variance value in mV² for each cutting test (i.e., each spindle speed/axial depth combination) is shown in FIG. 6. A dramatic increase in variance from 48 mV² to 709 mV² is seen for the transition from 2.79 mm to 3.56 mm axial depth at 15000 rpm. Larger depths of 4.32 mm and 5.08 mm also show increasing variance values. These large values indicate an increase in the spread of the data and identify unstable cutting conditions. The unstable cuts are denoted by large variance values, reference numerals 60, 61 and 62 in FIG. 6. All other spindle speed/axial depth combinations are stable, exhibiting small variance values. These results agree with independent evaluations of the process stability including surface finish measurements of the machined workpiece using a scanning white light interferometer and FFT-based analyses of the milling audio signal. (The comparison to FFT results necessitated the high sampling rates for data capture.) To further emphasize the dramatic difference in the distribution of the synchronously sampled data between stable and unstable cuts, a histogram chart shown in FIG. 7 was developed. FIG. 7 shows equally scaled histograms for each of the cutting tests. As described above, the stable cuts show tightly grouped distributions, while the three unstable cuts demonstrate a much wider spread in the data as shown by histograms 70, 71 and 72.

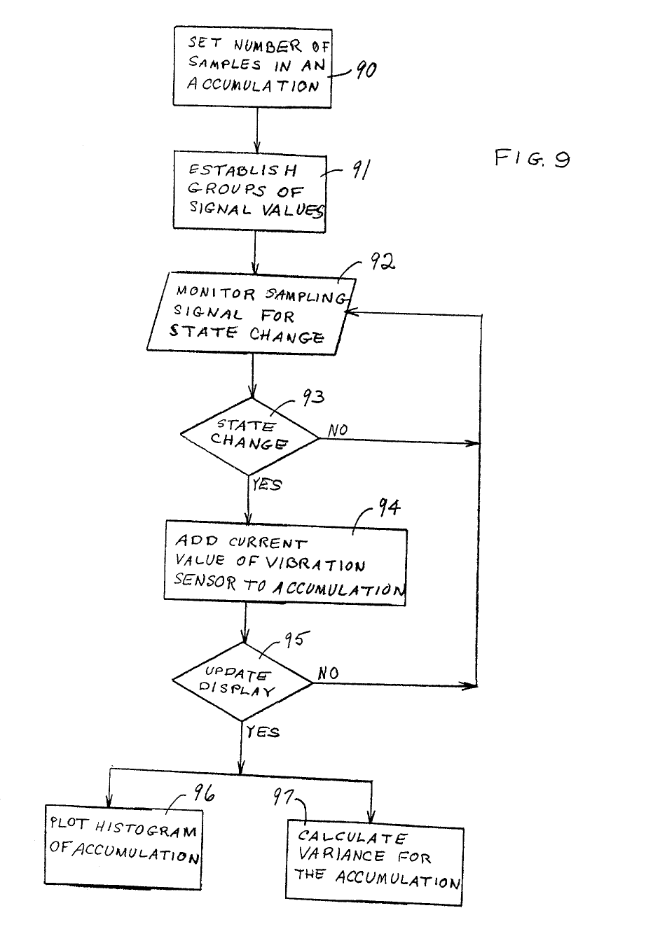

In condition-based monitoring applications, it is generally preferred to simplify the architecture of the sensors and required hardware as much as possible. Toward that end, analysis was made utilizing a sampling signal derived from the nominal spindle speed as opposed to actually sampling a once-per-revolution signal such as with the emitter/detector 22 shown in FIG. 2. Nominal spindle speed typically differs slightly from the actual spindle speed and therefore the sampling signals are not in exact synchronism with tool revolution. For the machine used in this study, a nominal or commanded spindle speed of 15,000 revolutions per minute (rpm) gave an actual spindle speed of 14,994.1 rpm. Analysis was made using linear interpolation when the number of samples per revolution was not an integer value. The resulting variance chart is shown in FIG. 8. It is seen that the variance values are somewhat higher than those shown in FIG. 6 due to the slightly asynchronous sampling involved when nominal speed is used, but the large relative increases in variance are still available to indicate the transition from stable to unstable cutting. Note that all variance values are relatively small except for the three unstable cuts, large variance values 80, 81 and 82. When nominal speed is used, the required components include only a unidirectional microphone or other appropriate sensor, a single channel of data acquisition, simple data processing to calculate the variance based on the nominal spindle speed, and a real-time display to provide monitoring of the condition-based process. A histogram chart based on the same data which produced FIG. 8 would look similar to the histogram chart, FIG. 7, showing the easily ascertained presence or absence of chatter. When presentations of data are made easily ascertainable, obvious benefits accrue for the machine operator (locally or remotely located) and the machining process.

The production of histograms and the calculation of statistical variance may be implemented by the processor 11 shown in FIG. 1. A vibration sensor 10, such as microphone 20 in FIG. 2, is used to provide an indication of vibration activity to the processor 11 and that signal is monitored once per revolution. The emitter/detector 22 shown in FIG. 2 may be used to provide a sampling pulse. For example, the falling edge of each sampling pulse from a normally high once-per-revolution output of the emitter/detector 22 can be used as a trigger to sample the vibration sensor output. Any sensor capable of providing the once-per-revolution signal is acceptable. For example, most machine spindles have an encoder, i.e., an angular position sensor that typically has a once-per-revolution pulse. That encoder signal could be used and would be preferred provided that the machine controller provides access to it. Also, while an audio vibration sensor is shown in FIG. 2, any type of vibration sensor can be used.

FIG. 9 provides for the analysis of the once-per-revolution sampled tool position data in order to analyze it in two complimentary fashions, one for the histogram and the other for variance. In FIG. 9, at step 90, the number of samples N to be taken in an accumulation is established. At step 91 if a histogram is to be produced, groups of signal values from the vibration sensor are established. For example, a first group from 0.25 to 0.3 mV²; a second from 0.3 to 0.35 mV², etc. At step 92 the in-process monitoring of the once-per-revolution sampling signal for a state change is performed, and at step 93 if a state change is sensed, the signal value from the vibration sensor is added to the accumulated data as shown in step 94. Thus, the number of occurrences of signal values falling in the first group, 0.25 to 0.3 mV² is recorded, the number of occurrences falling in the second group is recorded, etc. Once the number of samples to be taken in a first accumulation is reached, the display is updated as shown at step 95, and the histogram is updated at step 96. If the statistical variance is calculated, then the variance values are updated as shown at step 97.

The update rate for calculating the instantaneous variance values and histogram charts can be varied as desired. A logical way is to select: (1) the number of revolutions of data that will be used for each calculation (thus defining a moving window along the once-per-revolution sampled data vector), and (2) the number of revolutions between new calculations. For example, the moving window may include the most recent 20 samples for updating the histogram and may be updated every 10 revolutions. In any case, the computational requirements are minimal.

FIG. 10 shows a sample visual display including both a histogram and a number “54” representing the variance value. By viewing such a display a machine operator can easily determine the status of the process health, and can also visually see any deterioration in the process since chatter conditions will cause the variance value to rise and cause the histogram to begin spreading. Rather than displaying the instantaneous value of the variance, it is also possible to plot a trend line showing the current and previous values of the calculated variance.

From the above description, it is clear that the invention provides data which identifies chatter conditions and can be used to initiate corrective action by a machine operator. The invention, applied to a plurality of machine tools, can be used to activate displays at a remote location for observation of several machines. The invention can easily be added to existing machine tools for immediate benefit with or without an interface to the machine controller. The invention can be implemented into a machine tool by manufacturers.

While the invention has been shown and described with reference to preferred embodiments thereof, it should be understood that changes in the form and details of the invention may be made therein without departing from the spirit and scope of the invention. For example, once per revolution sampling signals are exampled herein but any periodic interval in synchronism with tool rotation is acceptable. As noted above, words referring to sampling in synchronism with the material removal operation include sampling with some slight asynchronism such as sampling at nominal spindle speed; the essence of the invention is method and device for obtaining clear indications of the presence or absence of chatter so that corrective action can be taken.

What is claimed is:

1. A method for identifying chatter conditions including the ability of identifying approaching chatter conditions between machine tool and workpiece in material removal operations comprising
providing a first signal capable of identifying chatter in the material removal operation;
providing a second signal at periodic intervals of the material removal operation in synchronism with tool rotation;
providing for sampling said first signal with the reception of said second signal over a selected number of said periodic intervals;
providing for a first accumulation of the synchronously sampled signals over the selected number of periodic intervals; and
providing for the analysis of the values of said synchronously sampled signals to supply an indication of whether the values are tightly grouped showing a stable operation without chatter or a spread distribution of values showing an unstable operation with the presence of chatter.

2. The method of claim 1 wherein providing for the analysis of the values of said synchronously sampled signals further includes
providing for the establishment of several groups of signal values;
providing for the allocation of each sampled signal to one of said groups of signal values;
providing for counting the number of occurrences of sampled signals in each group over said first accumulation;
providing for the plotting of a histogram showing the number of occurrences in each group; and
providing for the display of said histogram to visually show tight or spread distribution of sampled signals so that action can be taken to alleviate a chatter condition if present.

3. The method of claim 2 further including
providing for a second accumulation of the synchronously sampled signals;
providing for the determination of the number of occurrences of sampled signals in each said group during said second accumulation; and
providing for the updating of the results of said first accumulation with said second accumulation to modify said histogram.

4. The method of claim 3 further including
providing for the modification of said histogram over n number of said accumulations; and
providing for a moving window by deleting said first accumulation when the n+1 accumulation is determined so that the most recent data is included in said histogram.

5. The method of claim 4 wherein said second accumulation includes a portion of signals in said first accumulation and wherein said n+1 accumulation includes a portion of signals in the n accumulation.

6. The method of claim 1 wherein said periodic interval occurs once with each revolution of said machine tool.

7. The method of claim 6 wherein said first signal is sampled upon the change of state of said second signal.

8. The method of claim 1 wherein providing for the analysis of the values of said synchronously sampled signals further includes
providing for the machine implemented calculation of the statistical variance in said first accumulation of the synchronously sampled data wherein relatively low variance values indicate stable operation.

9. The method of claim 8 wherein providing for the calculation of variance values further includes
providing for the calculation according to
$${σ}^{2} = \frac{{\sum }_{i = 1}^{N} ( {x}_{i} - {x}_{m}^{2} )}{N - 1} , where {x}_{m} = \frac{{\sum }_{i = 1}^{N} {x}_{i}}{N} \qquad ( 1 )$$
wherein N=the number of sampled values in an accumulation and x=the value of each synchronously sampled signal in said accumulation.

10. The method of claim 9 further including
providing for the display of the calculated variance so that action can be taken to alleviate chatter conditions if present.

11. The method of claim 9 further including
providing for a second accumulation of the synchronously sampled signals;
providing for the machine implemented calculation of variance in said second accumulation;
providing for variance calculations over n number of accumulations; and
providing for the deletion of said first accumulation when the n+1 accumulation is determined so that only the most recent data is included.

12. The method of claim 11 wherein said second accumulation includes a portion of signals in said first accumulation and wherein said n+1 accumulation includes a portion of signals in the n accumulation.

13. Apparatus for identifying chatter conditions including the ability of identifying approaching chatter conditions produced at a machine tool/workpiece interface in material removal operations comprising
a vibration sensor located near said interface to produce first signals indicative of tool and/or workpiece vibration;
a processor connected to said vibration sensor to receive said first signals;
a source of sampling signals to enable said processor to record the value of said first signal at periodic intervals in synchronism with tool rotation;
said processor capable of accumulating sampled first signal values over a selected number of said periodic intervals; and
said processor capable of supplying an indication of whether the accumulation of said sampled first signal values are tightly grouped showing a stable operation without chatter or a spread distribution of values showing an unstable operation with the presence of chatter.

14. The apparatus of claim 13 further including
a display connected to said processor to visually show tight or spread distributions of said sampled values.

15. The apparatus of claim 13 wherein said source of sampling signals is an emitter/detector located near said tool to detect at least a portion of each revolution of said tool and generate a sampling signal used by said processor to trigger sampling of said first signal in synchronism with tool rotation.

16. The apparatus of claim 13 wherein said source of sampling signals is the nominal spindle speed of said tool enabling said processor to trigger sampling of said first signal at said periodic intervals.
